(19) United States
(12) Patent Application Publication
(10) Pub. No.: US 2014/0379383 A1
(43) Pub. Date: Dec. 25, 2014

(54) PROPERTY DAMAGE ASSESSMENT TOOL

(71) Applicant: IT Strategies Group, Inc., (unknown)

(72) Inventors: Daniel Jacobs, Ft. Lauderdale, FL (US); Hendrik Sienema, Ft. Lauderdale, FL (US); Craig Sienema, Ft. Lauderdale, FL (US); Jesse Smith, Hollywood, FL (US)

(73) Assignee: IT STRATEGIES GROUP, INC.

(21) Appl. No.: 13/923,422

(22) Filed: Jun. 21, 2013

(51) Int. Cl. G06Q 40/08

(52) U.S. Cl. CPC G06Q 40/08
USPC 705/4

(57) ABSTRACT

A property damage assessment tool is a cloud based, user-friendly property damage assessment tool designed to create a quick property damage estimate within minutes and requires no prior knowledge of insurance or public adjusting. The property damage assessment tool includes granting a user with electronic access, wherein the tool electronically provides, generates, receives, processes and updates the property damage assessment information to produce a comprehensive property damage estimate report within minutes. The property damage assessment tool further includes a marketplace that features an online community of service providers and other users, wherein the user can interact with the service providers and other members.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The present invention is directed to a cloud based, time-saving, user-friendly property damage assessment tool that accurately processes property damage claims to generate a comprehensive property damage estimate report within five minutes or less. The present invention is a must have for homeowners, commercial property owners, professional servicers, law firms, accounting firms, and claims preparation firms.

### BACKGROUND OF THE INVENTION

One of the shortcomings of the existing property damage assessment tools is that they are long and exhaustive in their operative abilities and take up to several hours if not days to generate property damage estimates.

One of the other shortcomings of the existing property damage assessment tools is that they are expensive to purchase and cannot be easily afforded by the general public.

Another one of the shortcomings of the existing property damage assessment tools is that they are not user-friendly and can only be used by the most experienced public adjusters, insurance experts, attorneys and contractors in the industry.

Another one of the shortcomings of the existing property damage assessment tools is that they create a great burden on personnel of insurance adjusters, law firms, accounting firms and claim preparation firms, especially in critical times of natural disasters, when many claims are filed at the same time.

Another one of the shortcomings of the existing property damage assessment tools is that they have complex contents and require hours of training, knowledge and experience in trade and insurance coverage.

Another one of the shortcomings of the existing property damage assessment tools is that they do not provide comprehensive estimate results to the user.

Yet another one of the shortcomings of the existing property damage assessment tools is that they do not incorporate an online community of service providers, public adjusters, actual members and legal service providers all in one place, and are readily available with their services.

The property assessment tool of the present invention alleviates the burdens of the existing property damage appraisal tools by its simplicity and accuracy of use.

The property damage assessment tool of the present invention significantly reduces the processing time of estimating property damage by creating a property damage estimate report within approximately five minutes or less.

The property damage assessment tool of the present invention is inexpensive to use and is available at reasonably priced comparable plans.

The property damage assessment tool of the present invention no longer requires extensive user intervention other than answering easy-to-use questions to generate comprehensive results. It vastly reduces the overall claim processing time for the user through automated computation and there is no longer a need to sift through countless hours of data interpretation to yield a property damage estimate.

The property damage assessment tool of the present invention requires no prior experience or expertise as a public adjuster, an engineer, an insurance expert, an attorney or a contractor. There is no experience necessary to use the present invention effectively, thus eliminating the need for experts.

The property damage assessment tool of the present invention is accurate in its results and can yield a dollar-for-dollar estimate on the property damage for the user. The user can take the said estimate to their insurance adjuster for a stress-free claim filing experience.

The property damage assessment tool of the present invention allows the user to know if the claims are inaccurate by granting access to an online community, where the user can then find local reviews, interact with other members, and find validated reviews on local service providers.

The property damage assessment tool of the present invention incorporates an online community property damage assessment tool marketplace. The marketplace permits the user to have added access to a stream of actual members, claim filers and expert service providers in the industry within the set geographical locale of the user. The service providers are given access only after qualified recommendations are given for them by said members, thus ensuring the best quality in their service and workmanship. Additionally, the service providers cannot pay for a positive or negative feedback and are validated strictly by the reviews of said members.

There is no other comprehensive property damage estimate tool currently available in the market, which is fast, accurate, inexpensive to use, requires no experience in claim filing, and is backed by an online community of actual members and service providers.

Therefore, there is a dire need for a quick, precise and automated property damage estimate tool that is simple to use, comprehensive in its results, requires no experience, relieves burdens on users, and is incorporated by a wide range of online community members and validated service providers.

For the foregoing reasons, the all-inclusive, cloud based, user-friendly property damage assessment tool can be used by all members of the general public with ease and efficiency. The property damage assessment tool is easily accessible, easily available, easily affordable, inexpensive to create, robust in its services, comprehensive in its algorithms and aesthetic in its features.

### SUMMARY OF THE INVENTION

According to the aspects illustrated herein, the property damage assessment tool of the present invention relates to a cloud based, user-friendly, property damage assessment tool designed to create a seamless and comprehensive property damage estimate report within a matter of five minutes or less. The present invention requires no knowledge or experience in filing insurance claims, interpretation of insurance coverage, or other relevant experience related to the field.

According to another aspect illustrated herein, the property damage assessment tool of the present invention can alleviate property damage estimation frustrations by increasing the accuracy of the estimates, by eliminating the need to buy other expensive tools and by decreasing the amount of time a user spends to yield a property damage estimate report.

According to another aspect illustrated herein, the property damage assessment tool of the present invention features a solution tool for property damage appraisal which can be accessed by the user by creating a user account through registration process via the Internet. The registration process includes: inputting user name, inputting user email, inputting user password and re-inputting user password

According to another aspect illustrated herein, the property damage assessment tool of the present invention allows the user to select a comparable plan based on the number of claims to be filed by the user as part of the purchasing software license process. The purchasing software license process includes: selecting an appropriate claim from the available comparable plans based on the number of claims that fit the user's claim filing needs.

According to yet another aspect illustrated herein, the user accesses the user account and answers a set of easy-to-use questions, which are assisted with pictures and visual aids. The purpose of the assisted pictures and visual aids is to simplify the complex insurance and public adjusting concepts.

According to additional aspects illustrated herein, the property damage assessment tool of the present invention outputs a comprehensive property damage estimate report based on information provided by the user through the easy-to-use questions.

According to yet other additional aspects illustrated herein, the property damage assessment tool of the present invention redirects the user to a welcome screen of the property damage assessment tool marketplace. Once in the property damage assessment tool marketplace, the user has the opportunity to find, review, and research expert service providers within a locale. The purpose of such resources is to assist the user in repairing the damage to the property and to represent the user against the insurer if needed. The said providers do not have a review board other than each state's government agency and/or the United States Department of Insurance.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

The subject matter, which is regarded as the invention, is particularly pointed out and distinctly claimed in the claims at the conclusion of the specification. Various other objects, features and attendant advantages of the present invention will become fully appreciated and apparent when taken in conjunction with the accompanying drawings, in which like reference characters designate the same or similar parts throughout the several views. Additionally, the left-most digit of a reference number identifies the drawing in which the reference number first appear, and wherein:

FIG. 1 is one embodiment of the property damage assessment tool providing for property damage estimates;

FIG. 2. is a flow chart illustrating the methods of using the property damage assessment tool;

FIG. 3 is a sample web page screen description shown on the user's computer or other computing devices prompting the user to register and create an account, in accordance with one embodiment;

FIG. 4 is a sample web page screen description shown on the user's computer or other computing devices displaying various pricing plans of the software license, in accordance with one embodiment;

FIG. 5 is a sample web page screen description shown on the user's computer or other computing devices displaying interactive questions within the property description field shown on the user's computer or other computing devises in reference to the first section of the property damage assessment tool, in accordance with one embodiment;

FIG. 6 is a sample web page screen displaying interactive questions within the basic insurance coverage information shown on the user's computer or other computing devices in reference to the second section of the property damage assessment tool, in accordance with one embodiment;

FIG. 7 is a sample web page screen displaying interactive questions within the basic insurance coverage information shown on the user's computer or other computing devices in reference to the third section of the property damage assessment tool, in accordance with one embodiment;

FIG. 8 is a sample web page screen displaying interactive questions within the property description information shown on the user's computer or other computing devices in reference to the fourth section of the property damage assessment tool, in accordance with one embodiment;

FIG. 9 is a sample web screen displaying the property damage estimate report shown on the user's computer or other computing devices in reference to the fifth section of the property damage assessment tool, in accordance with one embodiment.

FIG. 10. is a sample web screen displaying the welcoming screen of the property damage assessment tool marketplace shown on the user's computer or other computing devices, in accordance with one embodiment;

FIG. 11. is a sample web screen displaying the property damage assessment tool marketplace as shown on the user's computer or other computing devices, after the user elects to enter into the marketplace, in accordance with one embodiment.

FIG. 12 is a sample web screen displaying service providers in the property damage assessment marketplace as shown on the user's computer or other computing devices, after the user elects to enter into the marketplace, in accordance with one embodiment.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

In accordance with the embodiments described herein, a property damage assessment tool is disclosed that overcomes the problems with the prior art as discussed above, by providing the user with a cloud-based, user-friendly property damage assessment tool designed to create a quick and comprehensive property damage estimate report within five minutes or less and requiring no prior knowledge or experience in the field.

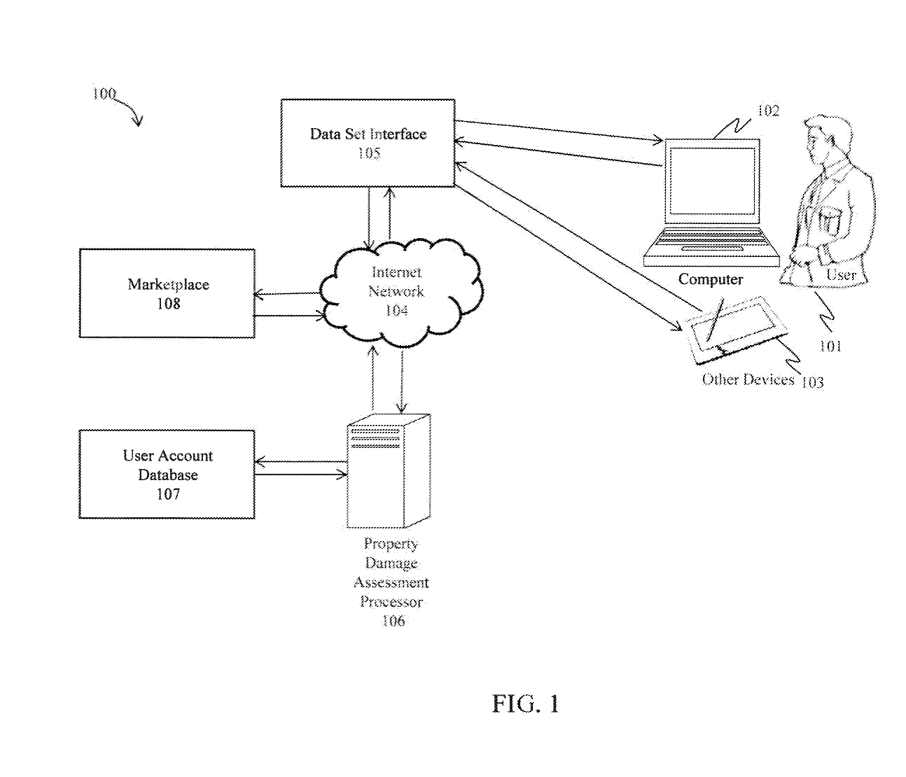

The embodiments of the property damage assessment tool will be described heretofore with reference to FIGS. 1 through 12 below. FIG. 1 illustrates one embodiment of the property damage assessment tool 100 providing for property damage estimates including a combination of a user 101, a computer system 102 or other computing devices 103, an internet network 104, a data set interface 105, a property damage assessment processor 106, a user account database 107 and a property damage assessment tool marketplace 108.

When a user 101, also referred to herein as a property owner, may be one or more users 101 interacting or interfacing with the property damage assessment tool 100 as described below. The computer system 102 may be any suitable processing device including a desktop or laptop computer. The other computing devices 103 may be any suitable processing devices including a mobile phone or smart phone, a tablet computer, a video game controller, or any other suitable stationary or mobile processing device or devices providing for user interface activity as described.

The internet network 104 may be any suitable network, including wired and/or wireless network(s). For example, the internet network 104 may be the Internet, but also can be a private network, or combination of networks, including a wireless network for mobile access to the Internet and routing of communications thereacross.

The data set interface 105 may be any suitable internet browser like, but not limited to GOOGLE CHROME, APPLE SAFARI, MOZILLA FIREFOX or MICROSOFT EXPLORER.

The property damage assessment processor 106 is one or more data storage devices performing processing operations described herein. The device(s) operate in relation to executable instructions from a computer based medium. The property assessment processor may be in a single processing environment or may be within a network of multiple processing environments.

The user account database 107 is one or more data storage devices storing user account information. As described in further detail below, the user account information provides for user name, user account password, financial information and other data.

The marketplace 108 is an online community of service providers, property owners, public adjusters, legal service providers and others.

In one embodiment, when the property owner 101 has damage to a property due to any or all forces of nature, the property owner 101 accesses the property damage assessment processor 106 by connecting a computer system 102 or any other computing device 103 to the internet network 104 via any suitable data set interface 105 available on the property owner's 101 computer system 102 or other computing device 103.

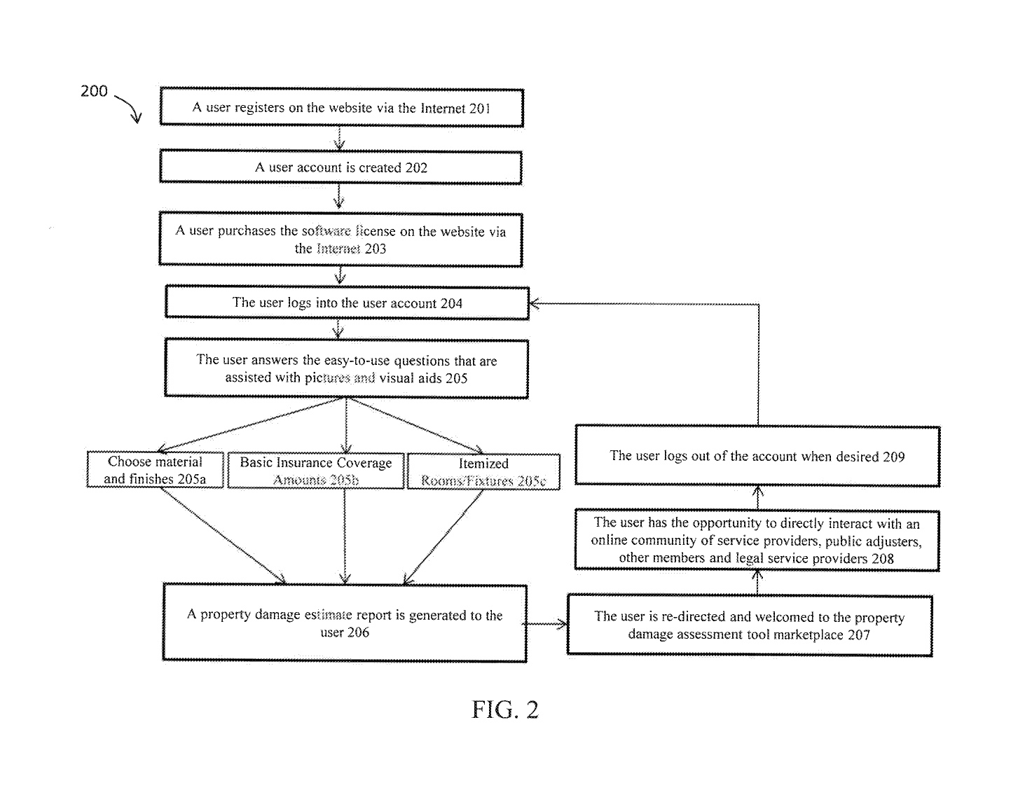

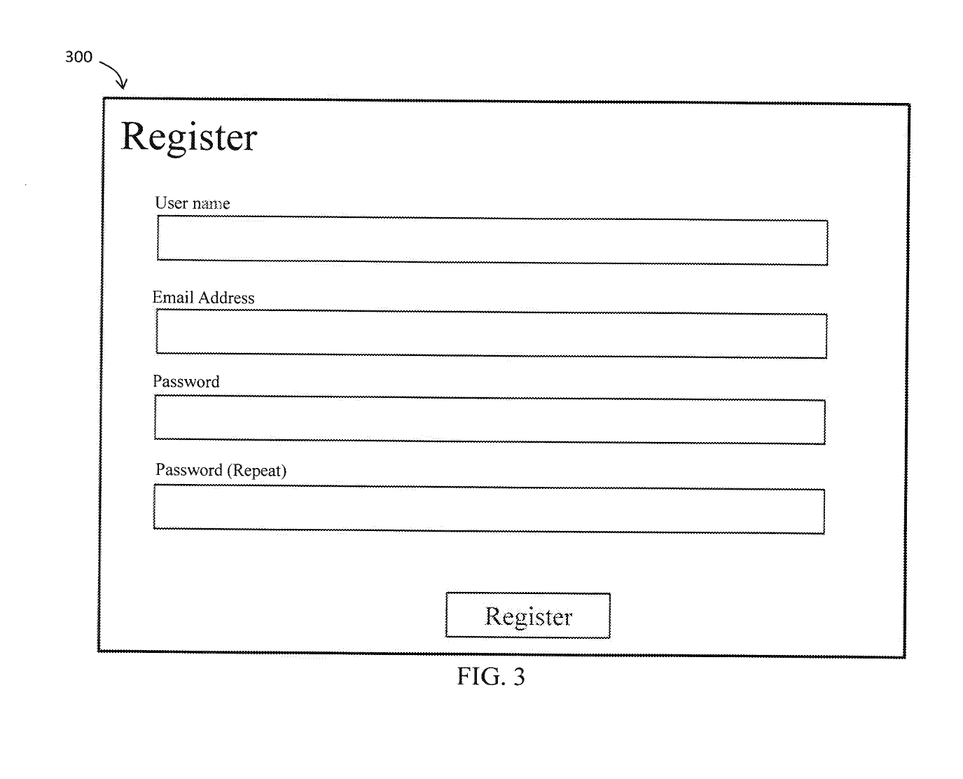

Shown in FIG. 2, 200, is a flow chart illustrating the detailed method for assessing property damage estimates. The steps of the flowchart represent one exemplary embodiment and are not limiting in nature. Moreover, the computerized processing operations may be performed by the property damage assessment processor 106 of the property damage assessment tool 100. A first step 201, as part of the registration process, first time users 101 may create a new account, including entering user information such as username, password, re-entering password and populating other applicable information. Existing users 101, who already have created a user account, may access the user account by re-entering user information such as username, password and/or other applicable user information. Wherein the user 101 has an existing account, the user may simply log in to the existing account. With a registered account, the user 101 becomes a member. A sample web input screen on the data set interface 105 via the internet network 104 prompting the user 101 to register is shown in FIG. 3, 300.

A next step 202, a user account is created and saved in the user account database 107 with all the user information, once the registration process is completed as shown in FIG. 3.

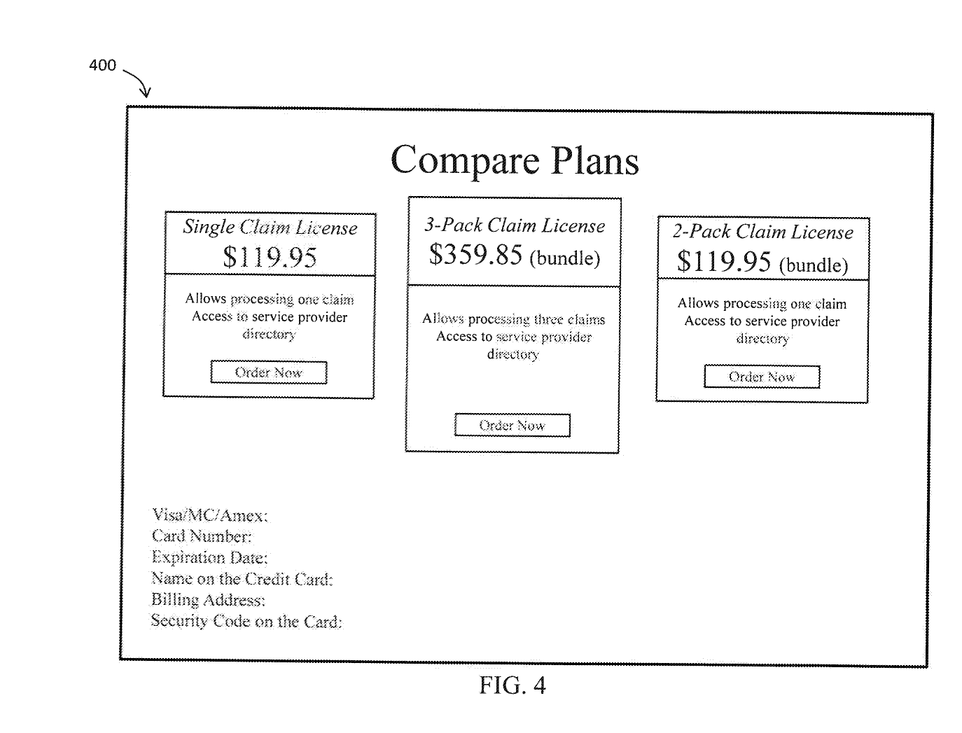

A next step 203, the user 101 purchases the software license of the property damage assessment tool 100. The purchasing process of step 203 is accomplished by the user 101 selecting license(s) from the available comparable plans, FIG. 4, 400. The pricing of the plans may be correlated to the number of claims to be filed. The user 101 may purchase a comparable plan or plans, including filling out the necessary financial payment information prompted to the user 101. The final purchase is made by the user 101 by clicking on the “order now” button on the data set interface 105 to process the purchase. The purchase of a comparable plan or plans may be processed as final only when the financial information entered by the user or users 101 is valid. A sample input screen illustrating the purchasing options available to the user 101 on the data set interface 105 via the internet network 104 is shown in FIG. 4.

A next step 204, once the software license is granted, a user account is created and the user 101 has the opportunity to use the property damage assessment tool 100. Existing users, who have unused software license(s), may use the said license(s) without having to necessitate step 202 and/or step 203. However, if existing users have used all the license(s) in a given comparable plan, the existing users may be subject to the purchasing process as in step 203, albeit not having to go through step 201.

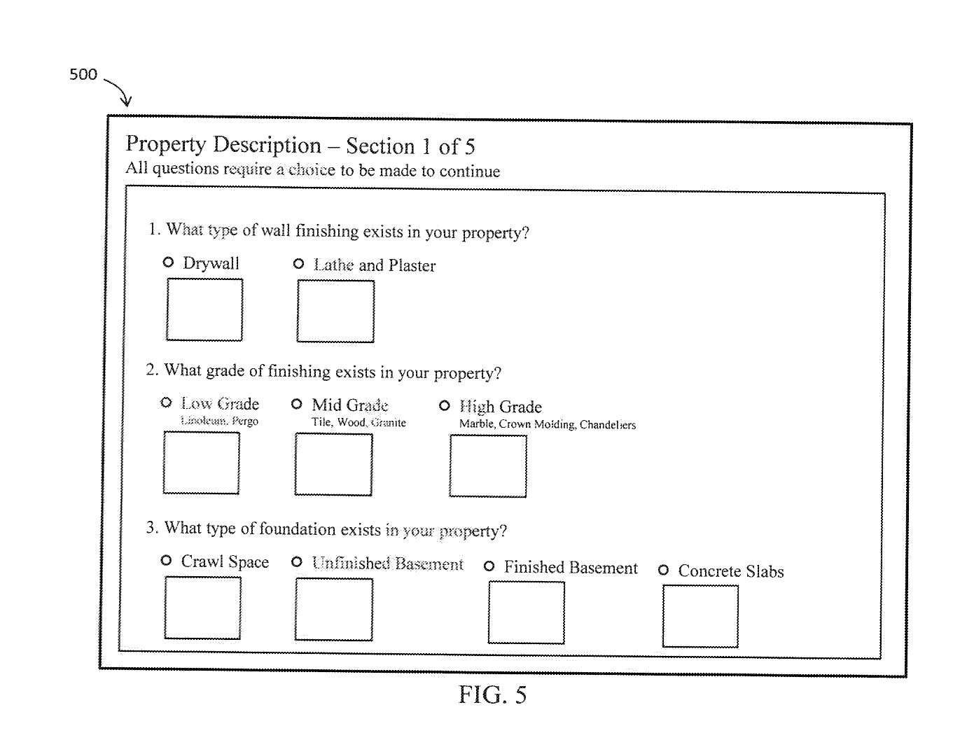

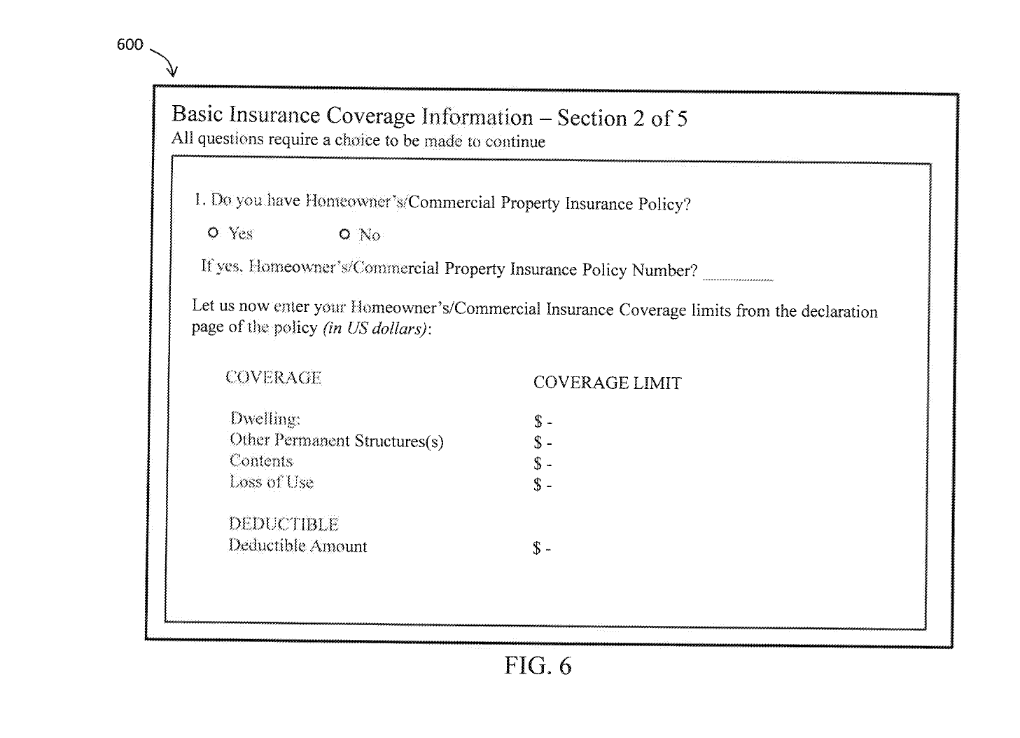

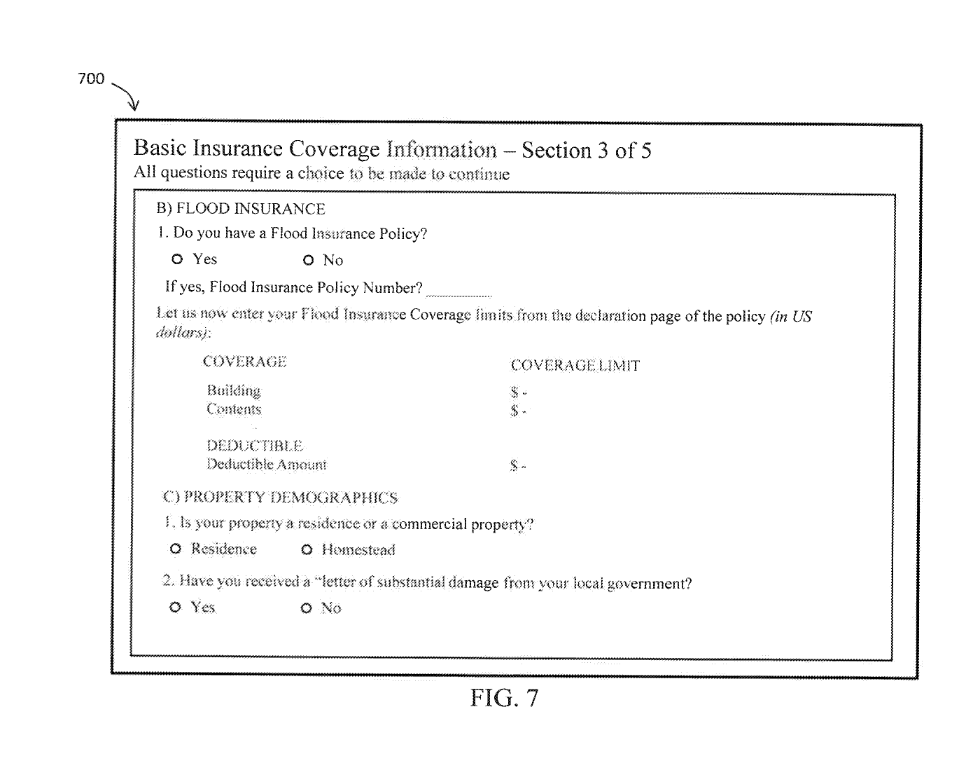

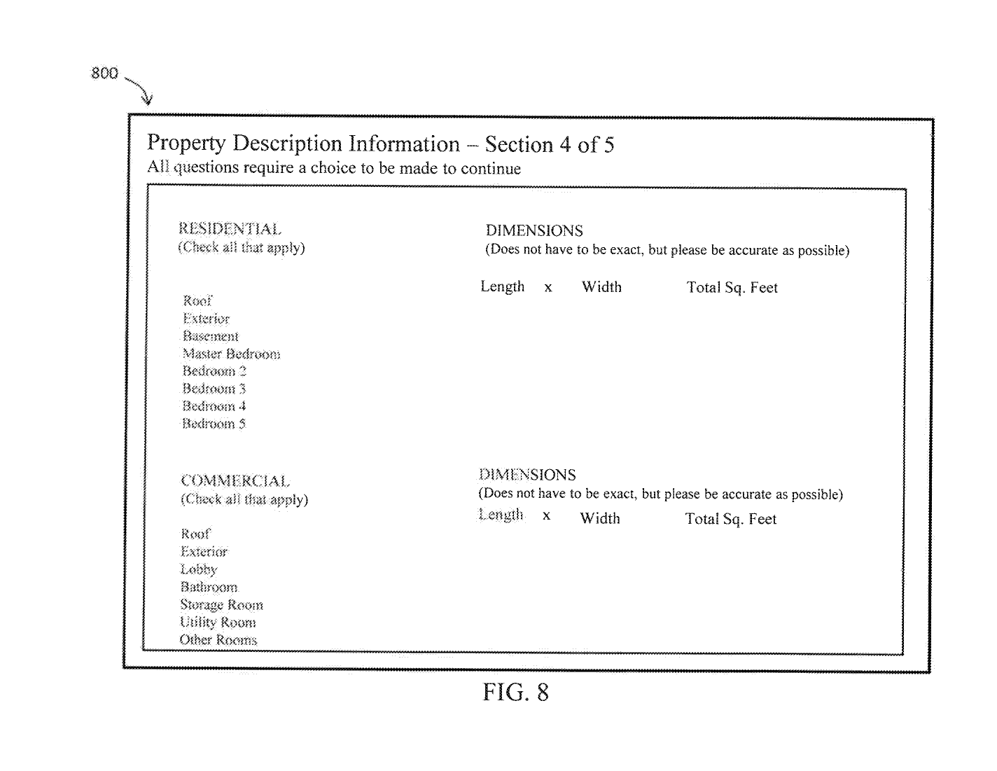

A next step 205, after the user 101 logs into the user account, the user 101 is engaged into a series of easy-to-use questions that are assisted with pictures and visual aids as illustrated in FIG. 2, FIG. 5, 500, FIG. 6, 600, FIG. 7, 700, and FIG. 8, 800. The series of questions with pictures and visual aids may include, but are not limited to: step 205a—choosing material and finishes applicable to the user, step 205b—entering basic insurance coverage amounts applicable to the user, and step 205c—itemizing damaged rooms and fixtures applicable to the user respectively. A sample input screen illustrating the said series of questions are shown in FIG. 5, FIG. 6, FIG. 7 and FIG. 8 respectively.

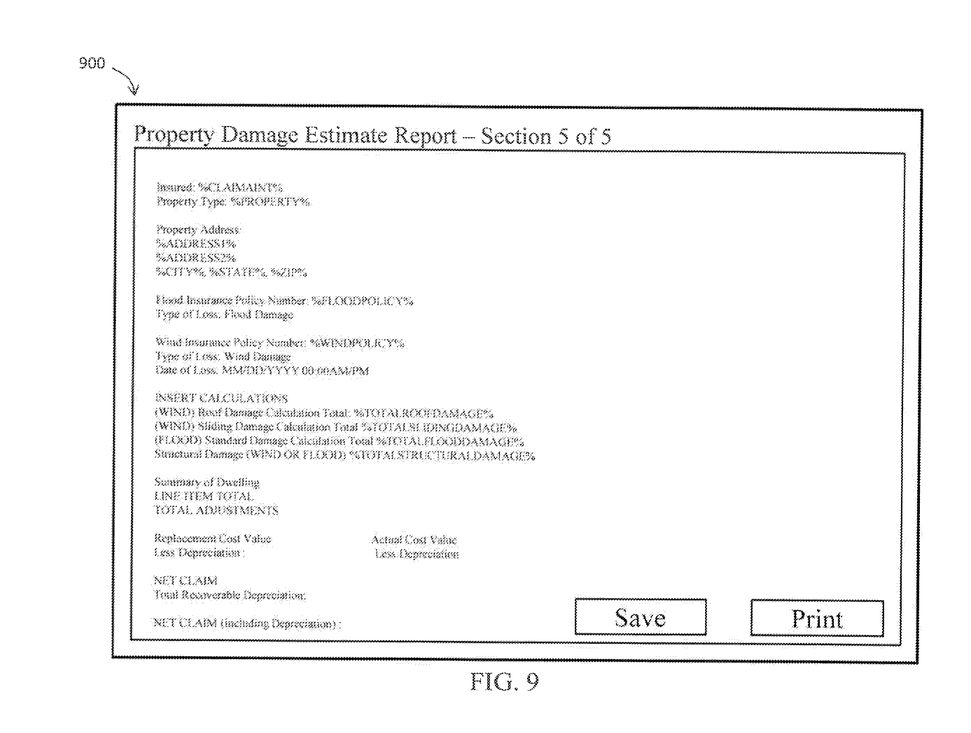

A next step 206, after the user 101 enters all the applicable information in steps 205a, 205b and 205c, the property damage assessment processor 106 manipulates all the information entered by the user 101 in steps 205a, 205b and 205c, saves all the user data entered in step 205 to the user account database 107, and then generates a property damage estimate report to the user 101 on the data set interface 105 via the Internet network 104 as shown in FIG. 1 and in FIG. 2. The user 101 may be given an option to save the property damage estimate report and/or print the property damage estimate report. A sample output screen of the said property damage estimate report available to the user or users 101 on the data set interface 104 is shown in FIG. 9, 900.

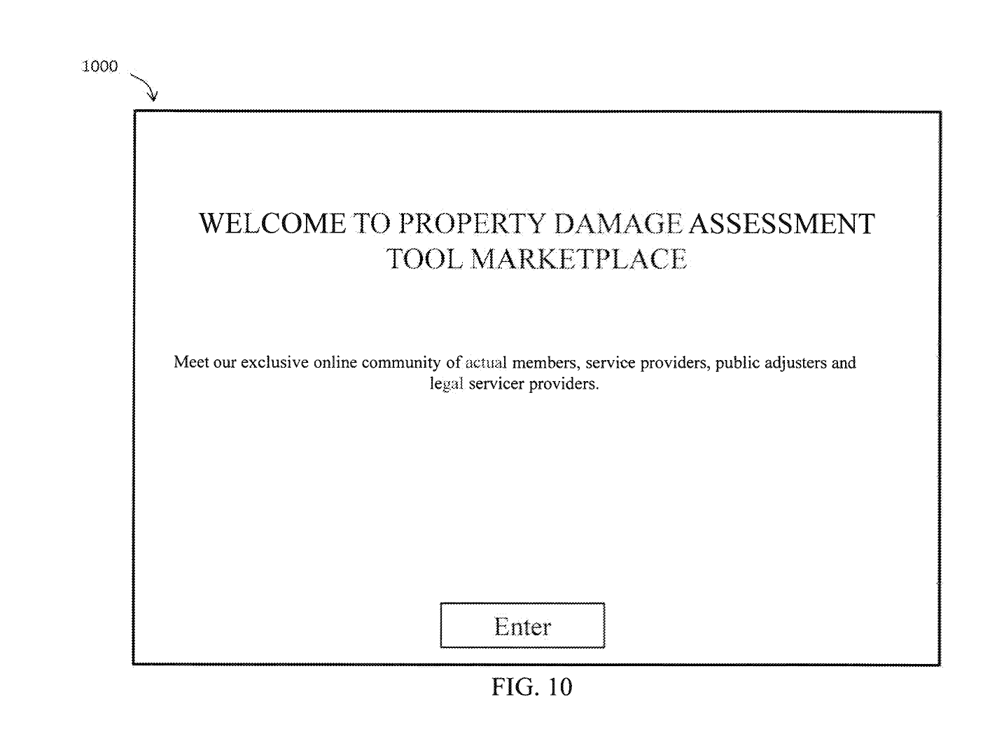

A next step 207, the user 101 is re-directed and welcomed to a graphical interface of the property damage assessment tool marketplace 108 via the internet network 104 as shown in FIG. 1, FIG. 2 and in FIG. 10, 1000.

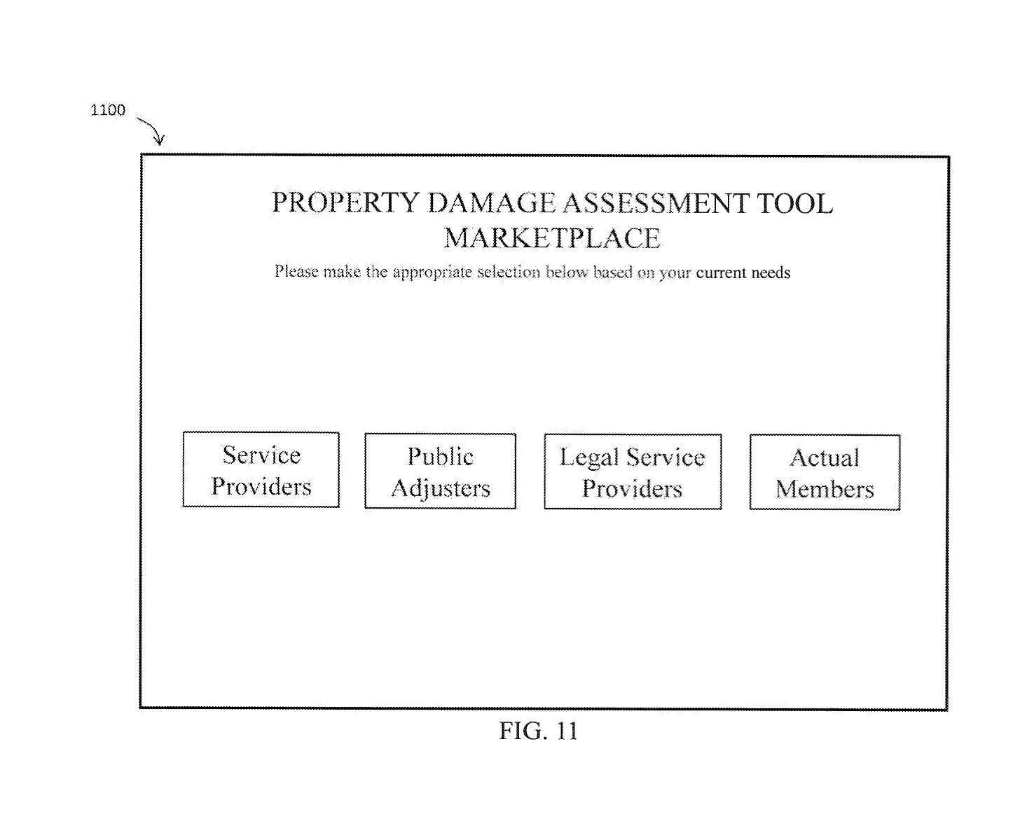

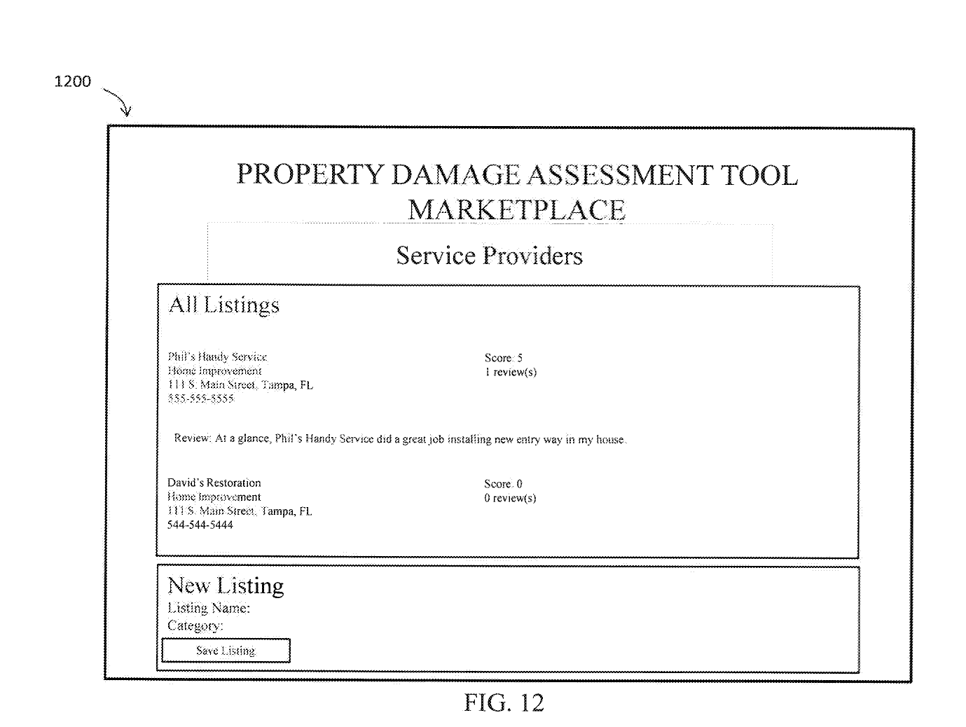

A next step 208, after entering into the Marketplace 108, the user 101 may directly interact with an online community of service providers, members, public adjusters, legal service providers and others as shown in FIG. 11, 1100, and FIG. 12, 1200.

A next step 209, the user 101 may “log out” of the user account at any time as and when the user may desire. Any preferences or information generated in steps prior to step 209 may be saved in the user account database 107 for the existing user 101 to access upon “logging back” into the user account.

While certain embodiments of the invention have been described, other embodiments may exist. Although the subject matter has been described in language specific to structural features, it is to be understood that the subject matter defined in the appended claims is not necessarily limited to the specific features or acts described above. Rather, the specific features and acts described above are disclosed as example forms of implementing the claims. Those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A computerized method for assessing property damage estimates, comprising:
via an electronic interface provided by a property damage assessment tool, granting a user electronic access to a user account associated to the user, wherein the user account includes a plurality of information pertaining to property damage assessment;
electronically providing from the property damage assessment tool a plurality of information to the user pertaining to property damage assessment;
electronically populating in the property damage assessment tool a plurality of questions for the user pertaining to property damage assessment;
electronically receiving in the property damage assessment tool a plurality of information from the user pertaining to property damage assessment;
electronically processing in the property damage assessment tool a plurality of information provided by the user pertaining to property damage assessment;
electronically updating in the property damage assessment tool a plurality of information provided by the user pertaining to property damage assessment;
electronically saving in the property damage assessment tool a plurality of information provided by the user pertaining to property damage assessment; and
providing a graphical interface to the user, including any property damage assessment information pertaining to the user account.

2. The method for assessing property damage estimates of claim 1, further comprising:
electronically manipulating in the property damage assessment tool, including each user's log in information, financial information and property damage assessment information.

3. The method for assessing property damage estimates of claim 1, further comprising:
electronically registering in the property damage assessment tool, including inputting user name, inputting user email, inputting user password and re-inputting user password.

4. The method for assessing property damage estimates of claim 1, further comprising:
electronically providing purchasing options in the property damage assessment tool, including a plurality of comparable price plans made available to the user.

5. The method for assessing property damage estimates of claim 1, further comprising:
electronically processing in the property damage assessment tool a plurality of financial payment options from the user, including electronically receiving suitable financial payments from the user.

6. The method for assessing property damage estimates of claim 1, further comprising:
electronically facilitating engagements between the user and an online community of service providers via the electronic interface provided by the property damage assessment tool.

7. The method for assessing property damage estimates of claim 1, further comprising:
electronically generating at least one property damage estimate report for the user based on property damage assessment information provided by the user.

8. A property damage assessment tool for assessing property damage, the property damage assessment tool comprising of;
a computer or other computing devices having readable medium, including executable instructions stored thereon;
a property damage assessment processor, in response to the executable instructions, operative to:
grant a user electronic access to a user account associated with the user, wherein the user account includes a plurality of information pertaining to property damage assessment;
electronically provide a plurality of information to the user pertaining to property damage assessment;
electronically populate a plurality of questions to the user pertaining to property damage assessment;
electronically receive a plurality of information from the user pertaining to property damage assessment;
electronically process a plurality of information from the user pertaining to property damage assessment;
electronically update a plurality of information from the user pertaining to property damage assessment;
electronically save a plurality of information from the user pertaining to property damage assessment;
provide a graphical interface to the user, including all property damage assessment information;
a user account database, operative to: electronically store a plurality of information from the user pertaining to property damage assessment, financial information and user account information; and
provide a property damage assessment tool marketplace, operative to: electronically access an online community of service providers, property owners, public adjusters, legal service providers and others.

9. The property damage assessment tool of claim 8, the property damage assessment processor further operative to: electronically manipulate each user's log in information, financial information and property damage assessment information.

10. The property damage assessment tool of claim 8, the property damage assessment processor further operative to: electronically register each user into a member, including inputting user name, inputting user email, inputting user password and re-inputting user password.

11. The property damage assessment tool of claim 8, the property damage assessment processor further operative to: electronically provide purchasing options, including a plurality of comparable price plans made available to the user.

12. The property damage assessment tool of claim 8, the property damage assessment processor further operative to: electronically process a plurality of financial payment options from the user, including electronically receiving suitable financial payments from the user.

13. The property damage assessment tool of claim 8, the property damage assessment processor further operative to: electronically facilitate engagements between the user and an online community of service providers via the electronic interface provided by the computerized property damage assessment tool.

14. The property damage assessment tool of claim 8, the property damage assessment processor further operative to:
electronically generate at least one property damage estimate report for the user based on a plurality of questions answered by the user.
